(19) United States
(12) Patent Application Publication
(10) Pub. No.: US 2018/0353948 A1
(43) Pub. Date: Dec. 13, 2018

(54) METHOD FOR PREPARING A CATALYZED FABRIC FILTER

(71) Applicant: Haldor Topsøe A/S, Kgs. Lyngby (DK)

(72) Inventors: Thomas Holten Kollin, Brønshøj (DK); Francesco Castellino, Birkerød (DK)

(73) Assignee: Haldor Topsøe A/S, Kgs. Lyngby (DK)

(21) Appl. No.: 16/068,849

(22) PCT Filed: Mar. 2, 2017
(86) PCT No.: PCT/EP2017/054880

§ 371 Date: Jul. 9, 2018

(30) Foreign Application Priority Data
Mar. 7, 2016 (DK) PA 2016 00142

(51) Int. Cl. B01J 35/06; B01J 31/06; B01J 23/648; B01J 21/06; B01J 37/02; B01J 37/08; B01D 39/08; B01D 39/20; B01D 53/86; B01D 46/02

(52) U.S. Cl. CPC B01J 35/065; B01D 2255/915; B01J 23/6482; B01J 21/063; B01J 37/0242; B01J 37/0236; B01J 37/088; B01D 39/086; B01D 39/2017; B01D 53/8653; B01D 53/8631; B01D 46/02; B01D 2239/10; B01D 2255/1023; B01D 2255/20723; B01J 31/06

(57) ABSTRACT

Method for preparing a catalytic fabric filter comprising the steps of a) providing a fabric filter substrate, preferably consisting of glass fibers, having a gas inlet surface and a gas outlet surface, the gas inlet surface is coated with a polymeric membrane, preferably consisting of polytetrafluoroethylene; b) providing an aqueous impregnation liquid comprising one or more catalyst metal precursor compounds; c) impregnating the fabric filter substrate with the impregnation liquid; and d) drying and thermally activating the impregnated fabric filter substrate at a temperature below 300° C. to convert the one or more metal compounds of the catalyst precursor to their catalytically active form, wherein the drying of the impregnated fabric filter substrate in step d) is performed from the gas outlet surface.

The present invention relates to the preparation of a catalyzed fabric filter and a catalyzed fabric filter prepared using this method.

Fabric filters are typically employed in the removal of particulate materials from flue gases emerging from industrial processes and combustion processes.

These filters are either produced with woven or non-woven fabric fibrous material providing a porous filtration media for capturing fine particulate matter without resulting in an undesired high pressure drop in the gases passing through the media.

Frequently off- and flue gases contain additionally gaseous compounds, which cause environmental or health hazards.

It has, thus, been a desire to reduce or remove the content of both particulate matter and hazardous compounds in off- and flue gasses simultaneously.

For this purpose, filtration media catalyzed with catalysts active in the conversion of hazardous compounds to less or harmless compounds have been employed in cleaning systems in the industry and automotive applications.

Fabric filters in form of e.g. filter bags are extensively used in many industries for removal of particulate matter from process gases. They are one of the most efficient types of dust collectors available and can achieve collection efficiencies of more than 99% for particulates. The filters can be made from various woven, non-woven or felted materials or mixtures thereof comprising natural fibres, synthetic fibres, or other fibres such as glass fibres, ceramic or metallic fibres.

The high particulate removal efficiency of fabric filters is partly due to the dust cake formed on the surfaces of the filter bags and partly due to the filter bag composition and production quality as well as the quality of the fabric filter construction itself. The fabric provides a surface on which dust particulates collect. Due to the composition of the fibers constituting the filter, these are typically operated at temperatures lower than 280° C., which causes several requirements and limitations to the methods for applications of catalysts onto the fabric filter material.

Dust filter bags based on glass fiber have typically two sides with a different surface. The exterior side, which is entrance side of dirty gas, is coated with a polymeric membrane that acts as a physical barrier and separates fine dust from dirty gas. The membrane is also decisive for the pressure drop across the bag. The interior side is not coated with a polymeric membrane.

As already mentioned above, in many applications it is a desire to remove or reduce also hazardous gaseous compounds from the dirty gas. For this purpose, the filter bags are impregnated with one or more catalysts active in the removal of the hazardous compounds.

In the preparation of catalyzed materials like fabric materials, aqueous impregnation liquids are preferred because of environmental and health reasons.

To this end, many of the fibres used in the manufacture of fabric filter consist of water repelling materials, which adds additionally requirements to application of catalytic materials onto the fibres when employing impregnation methods with aqueous impregnation liquids.

When preparing catalyzed fabric filters it is important to disperse the catalytic material finely across the entire thickness of the fabric filter substrate in an amount to provide optimal catalytic efficiency and to prevent formation of excessive pressure drop by amounts of the catalytic material coated on the filter substrate.

A further problem with impregnating filter bags provided with a polymeric membrane lies in accumulation of the catalyst particles mainly in the exterior surface facing the polymeric membrane, which increases the pressure drop to an unacceptable value.

The invention provides a method to apply high catalyst loading of up to 15 wt % without a significant pressure drop penalty to obtain simultaneous fine dust separation and emission abatement. The catalyst is mainly placed on the interior side of the fabric filter, i.e. in the opposite side of the membrane. Thereby, the addition of catalyst does not significantly increase the pressure drop. On the contrary, however, our data shows that low amount of catalyst (>2.8 wt %) placed on the exterior membrane side significantly increases the pressure drop.

It is commonly accepted in the art of catalysis that an effective supported catalyst requires coverage of the catalytic active material as a monolayer on surface of catalyst support particles. Thereby, it is possible to limit the required amount of supported catalyst on a fabric substrate.

Additionally, it is required that the catalyst particles do not form large agglomerates during drying and activation of the impregnated fabric filter.

As mentioned above, a number of the fiber materials used in the preparation of fabric filters are water repelling and aqueous impregnation liquids typically employed in e.g. catalyzing ceramic surfaces have a limited or no wetting ability to spread readily and uniformly over the surface of the fibres to form a thin and continuous catalyst layer.

Thus, it is a general object of the invention to provide a method for the preparation of catalyzed fabric filters by impregnation of the fabric material with an aqueous impregnation liquid containing catalytic active material/s that complies with the above mentioned requirements.

Pursuant to the above findings, this invention provides a method for preparing a catalyzed fabric filter comprising the steps of

a) providing a fabric filter substrate having a gas inlet surface and a gas outlet surface, the gas inlet surface is coated with a polymeric membrane;
b) providing an aqueous impregnation liquid comprising one or more catalyst metal precursor compounds;
c) impregnating the fabric filter substrate with the impregnation liquid; and
d) drying and thermally activating the impregnated fabric filter substrate at a temperature below 300° C. to convert the one or more metal compounds of the catalyst precursor to their catalytically active form, wherein
the drying of the impregnated fabric filter substrate in step d) is performed from the gas outlet surface.

Preferred embodiments of the invention are disclosed and discussed in the following. These embodiments can either be employed each alone or in combination thereof.

In one embodiment the thermally activation in step d) is performed from the gas outlet surface. Preferably, the thermal activation temperature is between 250 and 280° C.

In another embodiment, the impregnating of the fabric filter substrate is performed from the gas outlet surface.

In further an embodiment, the fabric filter substrate is in form of a bag.

The filter bags coated with a polymeric membrane on the gas inlet side have typically a thickness of about 0.8 mm. In accordance with a preferred embodiment of the invention, the filter bag is impregnated with the impregnation liquid from the gas outlet side, which selectively places the catalytic material on the opposite side of the membrane to further lower the pressure drop.

For this purpose, the bag is preferably inverted in relation to how it is used in operation of the filter bag, i.e. the gas outlet side is turned out prior to drying and prior to impregnation with the catalyst liquid.

Drying is then performed from the gas outlet side and the catalyst migrates to the water evaporation surface, i.e. the gas outlet side preventing accumulation of the catalyst particles on the gas inlet site coated with the polymeric membrane.

A number of fabric filter substrates have been found to have low thermal stability while other materials deactivate the catalytic material.

Thus, a preferred fabric filter substrate consists of woven or non-woven glass fibres. This substrate can withstand temperatures of up to 280° C.

By the same reasons, the polymeric membrane preferably consists of polytetrafluorethylene having high temperature stability.

The particle-containing off or flue gases very often contain nitrogen oxides (NOx), volatile organic compounds (VOC), SO₂, CO, Hg, NH₃, dioxins and furans, in concentrations that have to be reduced depending on local legislation. The abatement of gaseous contaminants like NOx, VOC, dioxins and furans can be effectively carried out by contact with a catalyst.

In preferred embodiments of the invention the one or more catalyst metal precursor compounds comprise ammonium metavanadate, ammonium metatungstate, ammonium heptamolybdate tetra hydrate, palladium nitrate, tetraammineplatinum(II) hydrogen carbonate or mixtures thereof and the catalytically active form of the catalyst metal precursor compound comprises one or more of vanadium oxide, tungsten oxide, molybdenum oxide, manganese oxide, copper oxide, iron oxide and palladium and platinum in the oxidic and/or metallic form.

In particular, vanadium oxide-based catalysts supported on titania, alumina, ceria, zirconia or mixtures thereof are commonly used catalysts for NOx reduction by selective reduction of NOx with NH₃ in stationary and automotive applications. Efficient oxidation catalysts are palladium or platinum in their oxidic and/or metallic form.

It is thus further preferred that the one or more catalyst precursor metal compound consists of ammonium metavanadate and palladium nitrate and the catalytically active form of the catalyst metal precursor compound consists of vanadium pentoxide and palladium.

These catalysts are active both in the removal of hydrocarbons (VOC) and carbon monoxide and in the removal of NOx by the SCR reaction with NH₃.

The oxidic metal carrier comprises preferably oxides of titanium, aluminum, cerium, zirconium or mixtures and compounds thereof.

It is further preferred that the oxidic metal carrier consists of nanoparticles of titanium oxide with a particle size of between 10 and 150 nm.

In the preparation of the impregnation liquid as disclosed in more detail below a part of the oxidic metal carrier hydrosol in the impregnation solution gelates during storage and agglomerates to a larger particle size than the preferred size. The primary amine dispersing agent prevents agglomeration or breaks down already formed agglomerates.

The primary amine is preferably soluble in the aqueous impregnation liquid, when having been added in an amount resulting in the above disclosed purpose. Primary amines with fewer than seven carbon atoms are water soluble, preferred primary amines for use in the invention are mono methyl amine, mono ethyl amine, mono propyl amine, mono butyl amine or mixtures thereof. Of these, the most preferred dispersing agent is mono ethyl amine.

Good results are obtained when the primary amine dispersing agent is added to the impregnation liquid in an amount resulting in a pH value of the impregnation liquid above 7.

In all the above embodiments of the invention it is further preferred that the prepared catalyzed fabric filter comprises from about 5 to about 15% by weight of catalytically active material.

The drying step and activation step in the above embodiments implies application of hot air on the gas outlet side of the impregnated fabric filter or otherwise applying heat on the gas outlet side by e.g. micro waves or radiation heat, such as infrared waves.

### EXAMPLE 1

Filter bags were wetted with catalytic liquid, dried from the gas inlet surface and heat treated at >240° C. Thereby, the catalyst was mainly placed on the exterior membrane side. The catalytic liquid was diluted with water in order to vary the amount of catalyst, see Table 1.

TABLE 1

| | | | Permeability |
|---|---|---|---|
| | | Wt % | at 200 Pa, |
| Sample | Drying | Catalyst | l/m²/s |
| X—blank | none | 0 | 65.2 |
| A | From gas | 3.25 | 22.6 |
| | inlet | | |
| B | From gas | 4.7 | 19.1 |
| | inlet | | |
| C | From gas | 6.8 | 20.9 |
| | inlet | | |
| D | From gas | 10.2 | 20.8 |
| | inlet | | |
| E | From gas | 13.5 | 15.3 |
| | inlet | | |

### EXAMPLE 2

Filter bags were wetted with catalytic liquid, dried from the gas outlet surface and heat treated at >240° C. Thereby, the catalyst was mainly placed on the interior side and not on the membrane. The catalytic liquid was diluted with water in order to vary the amount of catalyst, see Table 2.

TABLE 2

| | | | Permeability |
|---|---|---|---|
| | | Wt % | at 200 Pa, |
| Sample | Drying | Catalyst | l/m²/s |
| X—blank | none | 0 | 65.2 |
| F | From gas | 6.6 | 65.7 |
| | outlet | | |
| G | From gas | 6.6 | 62.4 |
| | outlet | | |
| H | From gas | 10.0 | 58.6 |
| | outlet | | |
| I | From gas | 10.0 | 49.1 |
| | outlet | | |

1. A method for preparing a catalyzed fabric filter comprising the steps of
a) providing a fabric filter substrate having a gas inlet surface and a gas outlet surface, the gas inlet surface is coated with a polymeric membrane;
b) providing an aqueous impregnation liquid comprising one or more catalyst metal precursor compounds;
c) impregnating the fabric filter substrate with the impregnation liquid; and
d) drying and thermally activating the impregnated fabric filter substrate at a temperature below 300° C. to convert the one or more metal compounds of the catalyst precursor to their catalytically active form, wherein
the drying of the impregnated fabric filter substrate in step d) is performed solely from the gas outlet surface.

2. The method of claim 1, wherein the thermally activation in step d) is performed from the gas outlet surface.

3. The method of claim 1, wherein the impregnating of the fabric filter substrate is performed from the gas outlet surface.

4. The method of claim 1, wherein the fabric filter substrate is in form of a bag.

5. The method of claim 4, wherein the gas outlet surface of the bag is turned out prior to step c) and/or step d).

6. The method of claim 1, wherein the fabric filter substrate consists of woven or non-woven glass fibers.

7. The method of claim 1, wherein the polymeric membrane consists of polytetrafluoroethylene.

8. The method of claim 1, wherein the one or more catalyst metal precursor compounds comprise ammonium metavanadate, ammonium metatungstate, ammonium heptamolybdate, palladium nitrate, tetraammineplatinum(II) hydrogen carbonate or mixtures thereof.

9. The method of claim 1, wherein the catalytically active form of the one or more catalyst metal precursor compounds comprises one or more of vanadium oxide, tungsten oxide, molybdenum oxide, manganese oxide, copper oxide, iron oxide, and palladium and platinum in the oxidic and/or metallic form.

10. The method of claim 9, wherein the catalytically active form of the one or more catalyst metal precursor compounds consists of vanadium pentoxide and palladium in metallic and/or oxidic form.

11. The method of claim 1, wherein the oxidic metal carrier comprises oxides of titanium, aluminum, cerium, zirconium or mixtures and compounds thereof.

12. The method of claim 11, wherein the oxidic metal carrier consists of nanoparticles of titanium oxide with a particle size of between 10 and 150 nm.

13. The method of claim 1, wherein aqueous impregnation liquid comprises a dispersing agent comprising a primary amine selected from one or more of the group consisting of mono methyl amine, mono ethyl amine, mono propyl amine and mono butyl amine.

14. The method of claim 13, wherein the dispersing agent consists of mono ethyl amine.

15. The method of claim 13, wherein the dispersing agent is added to the aqueous impregnation liquid in an amount resulting in a pH value above 7 of the impregnation liquid.

16. The method of claim 1, wherein the catalyzed fabric substrate comprises from about 5 to about 15% by weight of catalytically active material.

17. The method of claim 1, wherein the one or more catalyst precursor metal compounds are ammonium metavanadate and palladium nitrate.

18. A catalyzed fabric filter substrate prepared by a method according to claim 1.
